(19) United States
(12) Patent Application Publication
(10) Pub. No.: US 2024/0322330 A1
(43) Pub. Date: Sep. 26, 2024

(54) BATTERY MODULE

(71) Applicant: HONDA MOTOR CO., LTD., Tokyo (JP)

(72) Inventor: Toshiyuki ARIGA, Saitama (JP)

(21) Appl. No.: 18/583,878

(22) Filed: Feb. 22, 2024

(30) Foreign Application Priority Data
Mar. 22, 2023 (JP) 2023-045144

(51) Int. Cl. H01M 50/242; H01M 50/178; H01M 50/211; H01M 50/262; H01M 50/289; H01M 50/533

(52) U.S. Cl. CPC H01M 50/242; H01M 50/178; H01M 50/211; H01M 50/262; H01M 50/289; H01M 50/533

(57) ABSTRACT

A battery module includes stacked battery cells each including an electrode stack, an exterior package storing the electrode stack, and lead tabs to which current collectors of the electrode stack are connected, wherein the lead tabs each include an extension that extends from the exterior package, the battery module includes fixation members that are disposed to be in contact with welding seals provided on an outer periphery of the exterior package, in a stack direction, and fix the battery cells, the fixation members have a larger width than a width of the welding seals, and ends of the fixation members adjacent to the electrode stack are disposed closer to the electrode stack than ends of the lead tabs adjacent to the electrode stack, in joint areas in which the current collectors and the lead tabs are joined to each other.

This application is based on and claims the benefit of priority from Japanese Patent Application No. 2023-045144, filed on 22 Mar. 2023, the content of which is incorporated herein by reference.

### BACKGROUND OF THE INVENTION

### Field of the Invention

The present invention relates to a battery module.

### Related Art

In recent years, research and development related to secondary batteries that contribute to promoting energy efficiency have been made in order to allow more people to access reasonable, reliable, sustainable, and advanced energy.

A secondary battery includes, for example, an exterior package of a laminated film or the like, storing an electrode stack. There is a problem that possible generation of gas from an electrolyte inside the exterior package reduces the sealing property at welding seals of the exterior package. To address the problem described above, a technique related to an assembled battery that includes a pressure contact member having a contact surface for pressing heat welding seals of the exterior case is disclosed (for example, see Patent Document 1).
Patent Document 1: Japanese Unexamined Patent Application, Publication No. 2004-103258

### SUMMARY OF THE INVENTION

According to the technique disclosed in Patent Document 1, the heat welding seals of the exterior case are uniformly pressed by the pressure contact member. However, with only simple fixation by pressing the heat welding seals, joints between current collectors and lead tabs may be broken when, for example, torsional stress is caused by non-uniform expansion of the exterior case and distortion of the heat welding seals.

The present invention has been made in view of the problem described above, and has an object to provide a battery module that can maintain the sealing property of the exterior package, and protect the current collectors and the lead tabs.
(1) The present invention relates to a battery module that includes stacked battery cells each including an electrode stack, an exterior package storing the electrode stack, and lead tabs to which current collectors of the electrode stack are connected, wherein the lead tabs each include an extension that extends from the exterior package, the battery module includes fixation members that are disposed to be in contact with welding seals provided on an outer periphery of the exterior package, in a stack direction, and fix the battery cells, the fixation members have a larger width than a width of the welding seals, and ends of the fixation members adjacent to the electrode stack are disposed closer to the electrode stack than ends of the lead tabs adjacent to the electrode stack, in joint areas in which the current collectors and the lead tabs are joined to each other.

According to the aspect (1) of the invention, the battery module that can maintain the sealing property of the exterior package, and protect the current collectors and the lead tabs, can be provided.
(2) In the battery module according to (1), the current collectors each include a joint joined to the lead tabs, and the fixation members are each disposed more outward from the electrode stack than an end of the joint adjacent to the electrode stack in the joint area.

According to the aspect (2) of the invention, stress concentration to the joint of the current collectors can be prevented. Consequently, the current collectors can be prevented from being broken.
(3) In the battery module according to (1) or (2), the fixation members each have a rounded surface facing the current collector in the joint area.

According to the aspect (3) of the invention, stress concentration to the joint of the current collectors can be further prevented. Consequently, the current collectors can be further prevented from being broken.
(4) In the battery module according to (1) or (2), the fixation members are provided in contact with parts of the exterior package each provided with the extension, and are used in combination with second fixation members provided in contact with parts without the extension of the exterior package, and the fixation members are made of a material different from a material of the second fixation members.

According to the aspect (4) of the invention, the fixation member and the second fixation member can be made of appropriate materials in accordance respectively with required functions.

### BRIEF DESCRIPTION OF THE DRAWINGS

FIG. 1 is a perspective view illustrating the configuration of a battery module according to a first embodiment;

FIG. 2 is an exploded perspective view illustrating the configuration of the battery module according to the first embodiment;

FIG. 3 is an exploded perspective view illustrating a state in which a plurality of battery modules is stacked according to the first embodiment;

FIG. 4 is a sectional view taken along line A-A illustrating a main part of the battery module according to the first embodiment;

FIG. 5 is a sectional view illustrating a main part of a battery module according to a second embodiment; and

FIG. 6 is a perspective view illustrating a configuration of a first member according to the second embodiment.

### DETAILED DESCRIPTION OF THE INVENTION

### Battery Module

### First Embodiment

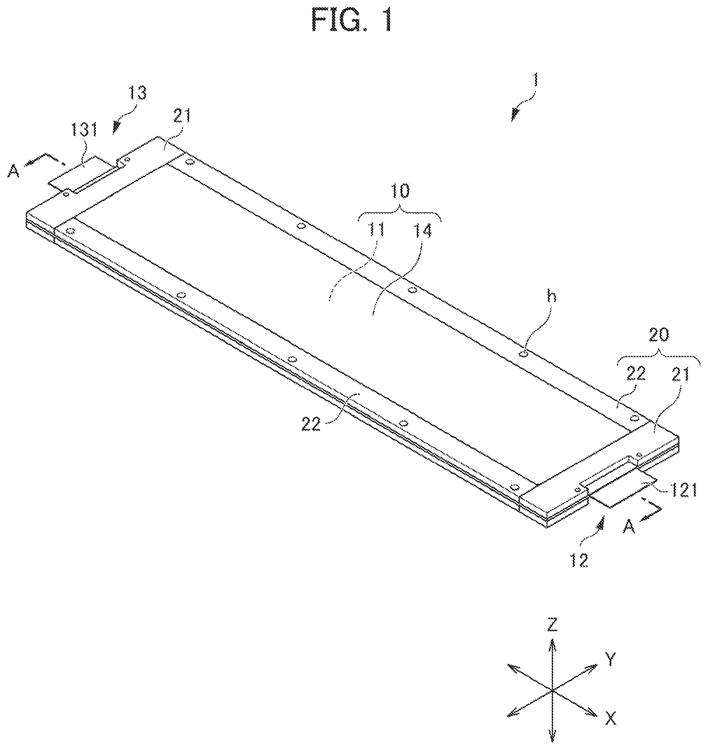

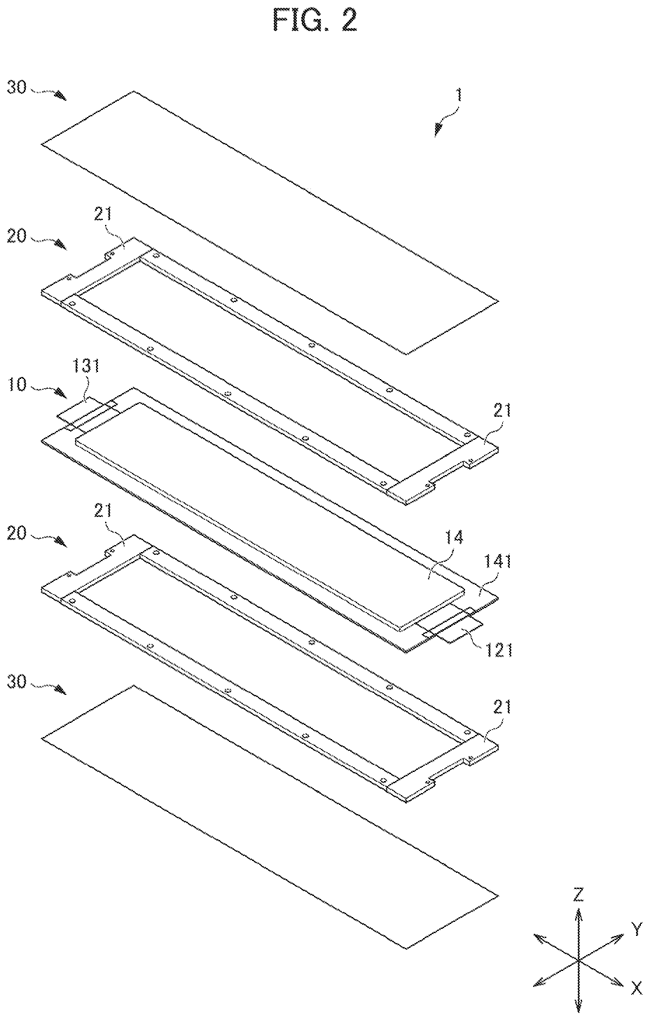

Hereinafter, a first embodiment of the present invention is described with reference to the drawings. As illustrated in FIGS. 1 and 2, a battery module 1 includes battery cells 10, and fixation members 21 that fixes the battery cells 10. Preferably, the fixation members 21 are combined with second fixation members 22, and are used as fixation frames 20.

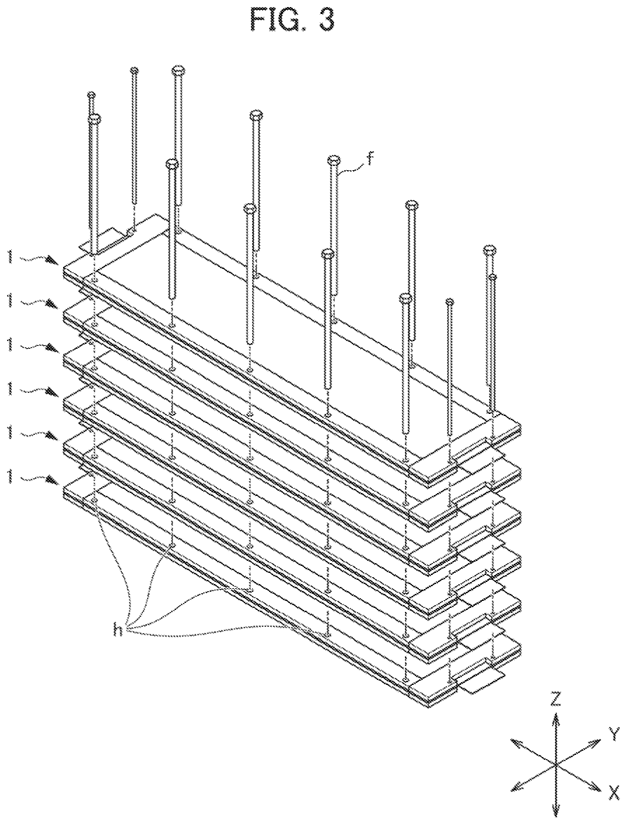

While the battery module 1 in FIG. 1 includes a single pair of battery cell 10 and fixation frame 20, the number of stack layers of battery cells 10 is not specifically limited. As illustrated in FIG. 3, the battery module may include a plurality of pairs of modules stacked in a stack direction Z, with the battery module 1 in FIG. 1 being adopted as a stacking unit. In such a case, the plurality of battery modules 1 is consolidated by respectively inserting fasteners f into a plurality of holes h formed in the fixation frames 20. As illustrated in FIG. 2, buffers 30 may be arranged between the battery modules 1.

### (Battery Cell)

As illustrated in FIG. 1 and the like, the battery cell 10 includes an electrode stack 11, a pair of lead tabs 12 and 13 to which current collectors of the electrode stack 11 are connected, and an exterior package 14 that stores the electrode stack 11. The battery cell 10 has a rectangular shape when viewed from the top surface (in the stack direction Z).

Although there is no limitation, the battery cell 10 may be, for example, a semi-solid-state lithium-ion battery cell including a gel-like electrolyte as an electrolyte, a liquid battery cell including an electrolytic solution, which contains an electrolyte and a solvent dissolved therein, or the like. This is because although in the aforementioned battery cell the inner pressure in the exterior package 14 is possibly increased by gas generated from the electrolyte or the electrolytic solution, the battery module 1 according to this embodiment can maintain the sealing property of the exterior package, and protect the current collectors and the lead tabs even if the inner pressure in the exterior package 14 increases.

Preferably, the battery cell 10 is a semi-solid-state lithium metal battery cell that uses lithium metal for negative electrodes, or a semi-solid-state lithium-ion battery cell that uses a silicon compound for negative electrodes. This is because these semi-solid-state batteries are relatively greatly expanded and contracted by charge and discharge.

The electrode stack 11 includes any number of stack layers each provided with a pair of a negative electrode and a positive electrode, an electrolyte layer disposed between the negative electrode and the positive electrode. The stack direction is the direction Z in each diagram. The negative electrode includes, for example, a negative electrode active material layer, and a negative electrode current collector. The positive electrode includes, for example, a positive electrode active material layer, and a positive electrode current collector.

The negative electrode active material layer is a layer that contains a negative electrode active material as an essential element. The negative electrode active material is not specifically limited, and may be, for example, any of lithium transition metal oxides, such as lithium titanate (Li₄Ti₅O₁₂), transition metal oxides, such as TiO₂, Nb₂O₃, and WO₃, metallic sulfides, metallic nitrides, carbon materials, such as graphite, soft carbon, and hard carbon, silicon-series materials, such as elemental silicon, silicon alloy, and silicon compounds, lithium metal, lithium alloy, metallic indium, etc.

The negative electrode current collector is not specifically limited, and may be, for example, metal foil, such as copper (Cu) foil, stainless steel (SUS) foil, or aluminum (Al) foil.

The positive electrode active material layer is a layer that contains a positive electrode active material as an essential element. The positive electrode active material is not specifically limited, and may be, for example, LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, sulfur, etc.

The positive electrode current collector is not specifically limited, and may be, for example, aluminum foil or the like.

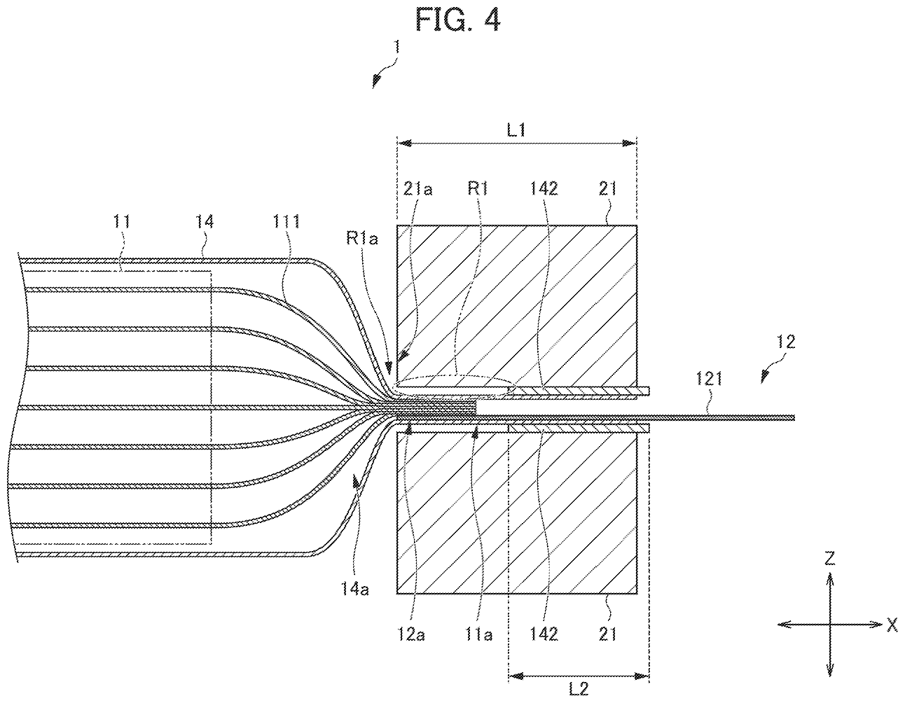

The pair of lead tabs 12 and 13 respectively include extensions 121 and 131 that extend from the exterior package 14. In the following description, the configurations of the negative electrode lead tab 12 and a negative electrode current collectors 111 are described. However, similar configurations can also apply to the positive electrode lead tab 13 and the positive electrode current collectors (not illustrated). As illustrated in FIG. 4, the lead tab 12 is joined, in a joint area R1, to the plurality of negative electrode current collectors 111 aggregated inside the exterior package 14. The direction in which the lead tab 12 extends from the exterior package 14 is a direction X in each diagram.

The exterior package 14 is made of a laminated film or the like, and internally stores the electrode stack 11. An outer periphery of the battery cell 10, i.e., an outer periphery 141 of the exterior package 14 is provided with welding seals (welding seals 142 in FIG. 4) where the exterior package is welded in an overlaid manner. The welding seals are provided on at least two sides of the outer periphery 141 where the extensions 121 and 131 are arranged. In addition, the welding seals may be provided also on two sides of the outer periphery 141 where the extensions 121 and 131 are not arranged.

As illustrated in FIG. 4, the exterior package 14 includes a gas holder 14a between each stack end of the electrode stack 11 and the outer periphery 141. Gas generated from an electrolyte or electrolytic solution is allowed to flow into and be stored in the gas holder 14a.

### (Fixation Member)

As illustrated in FIG. 4, the fixation members 21 are disposed so as to be in contact, in the stack direction Z, with the welding seals 142 at the parts of the outer periphery 141 where the extensions 121 and 131 are provided. According to this embodiment, a pair of fixation members 21 is arranged respectively above and below the extensions 121 and 131 in the stack direction Z. By a pair of fixation members 21, a short side of the outer periphery 141 is clamped via the welding seals 142 with the lead tabs 12 and 13, and is fixed. By the fixation members 21, the sealing property of the exterior package 14 can be maintained, and the lead tabs 12 and 13, and the current collectors connected to the lead tabs 12 and 13 can be protected from stress, such as torsional stress due to non-uniform expansion of the exterior package 14 and the distortion of the heat welding seals.

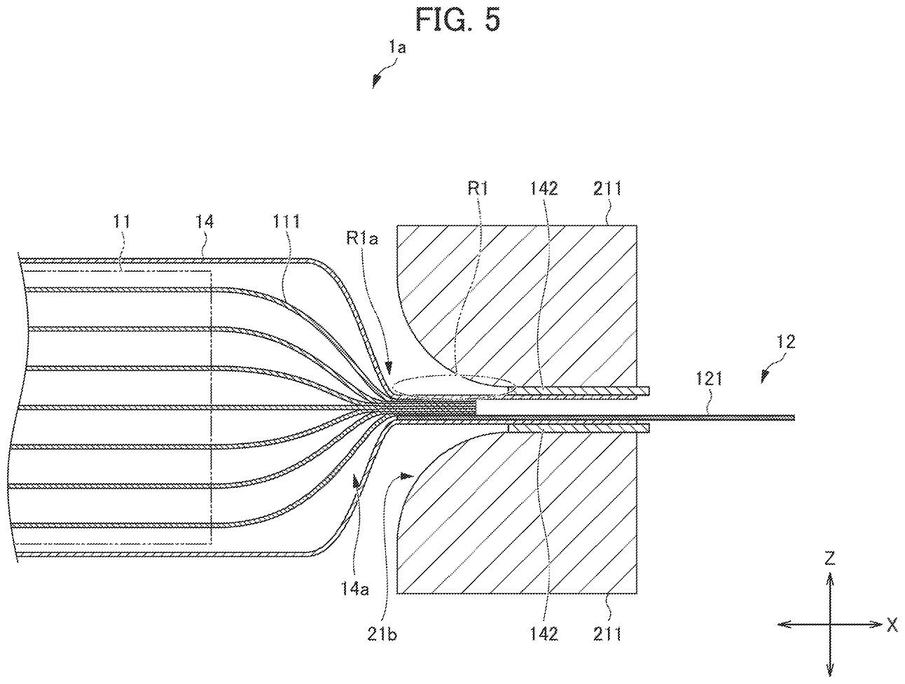

FIG. 4 is a sectional view taken along line A-A illustrating the extension 121 and therearound in FIG. 1 in an enlarged manner. As illustrated in FIG. 4, the width of the fixation member 21, i.e., the length Li of the fixation member 21 in the direction in which the lead tab 12 extends (the direction X in FIG. 4), is larger than the width of the welding seal 142, i.e., the length L2 of the welding seal 142 in the direction X. An end 21a of the fixation member 21 adjacent to the electrode stack 11 is disposed closer to the electrode stack 11 than an end 12a of the lead tab 12 adjacent to the electrode stack 11, in the joint area R1 (note that in FIGS. 4 and 5, the stack structure of the electrode stack 11 is omitted, and only the configuration of the negative electrode current collectors 111 is schematically illustrated). Accordingly, when the battery cells 10 expand and contract or when the gas holder 14a of the exterior package 14 expands and contracts, the lead tab 12 is pulled, which prevents stress from being applied to the negative electrode current collectors 111. Consequently, the sealing property of the exterior package 14 can be maintained, and the current collectors and the lead tabs can be protected.

Preferably, the fixation member 21 completely covers the end of the welding seal 142 adjacent to the electrode stack 11 in the top view. Accordingly, degradation of the sealing property of the exterior package 14 by application of stress to the welding seals 142 in case of expansion and contraction of the gas holder 14a of the exterior package 14 can be prevented. The fixation member 21 may completely cover the welding seal 142 in the top view.

As illustrated in FIG. 4, it is preferable that the end 21a of the fixation member 21 adjacent to the electrode stack 11 be disposed more outward from the electrode stack 11 than an end R1a of a joint 11a of each negative electrode current collector 111 with the lead tab 12 adjacent to the electrode stack 11, in the joint area R1. Thus, the end R1a of the negative electrode current collectors 111 is not fixed, and a portion that is bent when the gas holder 14a of the exterior package 14 expands and contracts serves as the end 21a of the fixation member 21. Accordingly, the end R1a can move freely to some extent following the expansion and contraction of the gas holder 14a. Consequently, when the gas holder 14a expands, the stress at the end R1a is more hardly concentrated than in the case in which the end R1a is fixed. Therefore, the negative electrode current collectors 111 can be prevented from being broken.

The fixation member 21 functions not only as the function of preventing stress from being concentrated on the welding seal 142 but also as a base of a bus-bar. The extension 121 is bent to be joined to the bus-bar in some cases, in which the fixation member 21 facilitates bending of extension 121. The quality of material of the fixation member 21 suitable for the function described above is not specifically limited. For example, a resin material is used.

Preferably, the pressure of clamping the outer periphery 141 by the pair of fixation members 21 is at least equal to or higher than an increased inner pressure with respect to gas generated inside the exterior package 14. It is more preferable that the pressure be equal to or higher than the resistant pressure of enclosure of the exterior package 14. Specifically, it is preferable that the clamping pressure described above be 0.05 MPa or higher, and it is more preferable that the pressure be 0.5 MPa or higher.

### (Fixation Frame)

Preferably, the pair of fixation members 21 is combined with the pair of second fixation members 22, and constitutes the fixation frame 20 formed to have a frame shape. The fixation frame 20 is arranged to clamp the outer periphery 141. According to this embodiment, the fixation frames 20 are arranged respectively above and below in the stack direction Z of the battery cells 10, clamp the outer peripheries 141 including the outer edges, and are fixed. The fixation frames 20 each clamp four sides of the battery cell 10 in the top view, and integrally fix the electrode stack 11 of the battery cells 10 and the exterior package 14, and the pair of lead tabs 12 and 13.

For example, it is preferable that in a case of using a material greatly expanding and contracting, such as lithium metal or silicon-series material, as the negative electrode active material, the buffers 30 be arranged between the battery modules 1. However, in the case of applying the buffers 30, torsional stresses possibly apply to the lead tabs 12 and 13. According to the configuration described above, the lead tabs 12 and 13, and the current collectors connected to the lead tabs can be preferably protected from torsional stresses and the like.

Preferably, in each fixation frame 20, the pair of fixation members 21 and the pair of second fixation members 22 are joined to each other. Besides the above description, the fixation frames 20 may be what is integrally formed. It is however preferable that the fixation members 21 and the second fixation members 22 be formed as separate elements. Accordingly, the fixation members 21 and the second fixation members 22 can be made of different materials in accordance with respectively required performances.

### (Second Fixation Member)

The second fixation members 22 are disposed so as to be in contact, in the stack direction Z, with parts of the outer periphery 141 where the extensions 121 and 131 are not provided. According to this embodiment, the pairs of second fixation members 22 are disposed respectively above and below the stack direction Z. Each long side of the outer periphery 141 is clamped by the pair of second fixation members 22, and is fixed.

As illustrated in FIG. 1, the holes h penetrated through the stack direction Z are formed in the second fixation members 22. As illustrated in FIG. 3, the fasteners f for stacking a plurality of battery modules 1 may be inserted into the respective holes h, or cooling members to cool down the battery modules 1 may be arranged in the holes h. An aspect of the cooling members may be, for example, chiller hoses. Accordingly, the temperatures of the battery modules 1 can be effectively adjusted. Note that holes h similar to those of the second fixation members 22 may be provided also in the fixation members 21.

The second fixation members 22 satisfying the function described above are not specifically limited. However, it is preferable that the members be made of a material having a stiffness and heat radiation property to some extent, and for example, made of a metal material, such as aluminized steel.

### Second Embodiment

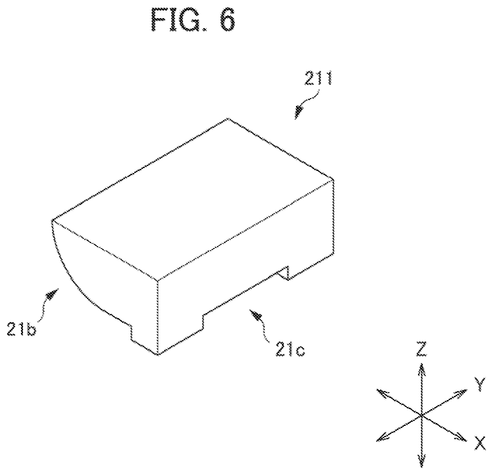

Next, a battery module 1a according to a second embodiment is described with reference to FIGS. 5 and 6. Note that configurations similar to those of the battery module 1 in the first embodiment described above are respectively assigned the same symbols, and their description is sometimes omitted.

The battery module 1a includes fixation members 211. Similar to the fixation members 21, the fixation members 211 are disposed so as to be in contact, in the stack direction Z, with the welding seals 142 at parts of the outer periphery 141 where the extensions 121 and 131 are provided. According to this embodiment, a pair of fixation members 211 are arranged respectively above and below extensions 121 and 131 in the stack direction Z.

Each fixation member 211 has a rounded surface 21b that faces the electrode stack 11 and the negative electrode current collectors 111 in the joint area R1. The fixation member 211 has the Rounded surface 21b described above, which makes the end R1a more hardly come into contact with the fixation member 211 during expansion and contraction of the gas holder 14a of the exterior package 14. Accordingly, during expansion of the gas holder 14a, stresses are more hardly concentrated on the end R1a. Therefore, the negative electrode current collectors 111 can further be prevented from being broken.

Preferably, as illustrated in FIG. 6, the fixation member 211 has a concave 21c formed on a surface to be contact with the outer periphery 141. The concave 21c is a concave where the joint between the lead tab 12 and the negative electrode current collectors 111 can be disposed in the joint area R1. The concave 21c allows the fixation member 211 to have a shape in conformity with the shape of the joint between the lead tab 12 and the negative electrode current collectors 111. Accordingly, the outer periphery 141 can be more preferably fixed by the fixation members 211.

The embodiments according to the present invention have thus been described above. However, the present invention is not limited to the embodiments described above, and can be appropriately changed. For example, the configuration according to the first embodiment and the configuration according to the second embodiment can be combined.

### EXPLANATION OF REFERENCE NUMERALS

1, 1a Battery module
11 Electrode stack
111 Negative electrode current collector (current collector)
11a Joint
12, 13 Lead tab
121, 131 Extension
14 Exterior package
141 Outer periphery
142 Welding seal
21 Fixation member
22 Second fixation member
R Joint area
Z Stack direction

What is claimed is:

1. A battery module comprising stacked battery cells each including an electrode stack, an exterior package storing the electrode stack, and lead tabs to which current collectors of the electrode stack are connected,
wherein the lead tabs each include an extension that extends from the exterior package,
the battery module includes fixation members that are disposed to be in contact with welding seals provided on an outer periphery of the exterior package, in a stack direction, and fix the battery cells,
the fixation members have a larger width than a width of the welding seals, and
ends of the fixation members adjacent to the electrode stack are disposed closer to the electrode stack than ends of the lead tabs adjacent to the electrode stack, in joint areas in which the current collectors and the lead tabs are joined to each other.

2. The battery module according to claim 1,
wherein the current collectors each include a joint joined to the lead tabs, and
the fixation members are each disposed more outward from the electrode stack than an end of the joint adjacent to the electrode stack in the joint area.

3. The battery module according to claim 1, wherein the fixation members each have a rounded surface facing the current collector in the joint area.

4. The battery module according to claim 1,
wherein the fixation members are provided in contact with parts of the exterior package each provided with the extension, and are used in combination with second fixation members provided in contact with parts without the extension of the exterior package, and
the fixation members are made of a material different from a material of the second fixation members.
